(19) United States
(12) Patent Application Publication
(10) Pub. No.: US 2009/0244222 A1
(43) Pub. Date: Oct. 1, 2009

(54) INK CARTRIDGES AND METHODS OF FORMING GROOVE IN INK CARTRIDGE

(75) Inventor: Michiko Aoyama, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/405,193

(22) Filed: Mar. 16, 2009

(30) Foreign Application Priority Data
Mar. 31, 2008 (JP) 200892824

(51) Int. Cl. B41J 2/175

(52) U.S. Cl. 347/86

(57) ABSTRACT

An ink cartridge includes a frame including a portion of a first chamber formed therein, and the first chamber is configured to store ink. The ink cartridge also includes a hollow portion positioned at a side wall of the frame. The hollow portion includes a second chamber formed therein, and the second chamber is continuous with the first chamber and extends from an inner surface of the side wall of the frame away from the first chamber. The ink cartridge also includes a movable member positioned in the second chamber and configured to move based on an amount of ink in the first chamber, and an inner surface of the hollow portion defining the second chamber has a groove extending toward the first chamber.

### CROSS-REFERENCE TO RELATED APPLICATION

The present application claims priority from Japanese Patent Application No. JP-2008-92824, which was filed on Mar. 31, 2008, the disclosure of which is incorporated herein by reference in its entirety.

### BACKGROUND OF THE INVENTION

1. Field of the Invention

The present invention relates generally to ink cartridges comprising a first chamber configured to store ink and a movable member configured to move in a second chamber in accordance with an amount of ink in the first chamber.

2. Description of Related Art

A known ink-jet printer is configured to print an image on a sheet of paper with ink. A known ink cartridge also is configured to be removably mounted to the printer. Such ink cartridges have an ink chamber formed therein, and the ink chamber is configured to store ink therein. When the ink cartridge is mounted to the printer, ink stored in the ink chamber is supplied to the printer.

Another known ink-jet printer, e.g., the ink cartridge described in Patent Application Publication No. JP 2007-268793A, has a case having an ink chamber formed therein, and a pivotable member positioned in the ink chamber. The pivotable member is configured to pivot based on an amount of ink remaining in the ink chamber. This known ink cartridge also has a translucent portion extending outwardly from the case, and the translucent portion has an inner space formed therein. A detection portion of the pivotable member is configured to move in the vertical direction in the inner space of the translucent portion. More specifically, when a predetermined amount of ink is stored in the ink chamber, the detection portion contacts a bottom inner surface of the translucent portion, and, when the ink stored in the ink tank is reduced and the ink amount becomes less than the predetermined amount, the detection portion moves vertically and away from the bottom inner surface of the translucent portion. Nevertheless, ink may accumulate on the bottom inner surface of the translucent portion. This accumulated ink may hinder the movement of the pivotable member. More specifically, the accumulated ink may contact the detection portion and retain the detection portion at the bottom inner surface when the detection portion attempts to move away from the bottom inner surface of the translucent portion. The bottom inner surface may be made inclined toward the ink chamber to remove the accumulated ink from the bottom inner surface, but the accumulated ink may not be removed consistently from the bottom inner surface.

### SUMMARY OF THE INVENTION

Therefore, a need has arisen for ink cartridges and methods of forming a groove in an ink cartridge which overcome these and other shortcomings of the related art. A technical advantage of the present invention is that ink is prevented from accumulating at a bottom inner surface of a hollow portion and a movable member moves smoothly.

According to an embodiment of the present invention, an ink cartridge comprises a frame comprising at least a portion of a first chamber formed therein, wherein the first chamber is configured to store ink. The ink cartridge also comprises a hollow portion positioned at a side wall of the frame, wherein the hollow portion comprises a second chamber formed therein, the second chamber is in fluid communication with the first chamber and extends from an inner surface of the side wall of the frame away from the first chamber. The ink cartridge further comprises a movable member positioned in the second chamber and configured to move in response to an amount of ink in the first chamber, wherein an inner surface of the hollow portion defining the second chamber has a groove formed therein and extending toward the first chamber.

According to another embodiment of the present invention, a method of forming a groove in an ink cartridge, the ink cartridge comprises a frame comprising a hollow portion positioned at a side wall of the frame, wherein the hollow portion comprises a chamber formed therein, the chamber extends from an inner surface of the side wall of the frame. The method of forming the groove comprises the steps of introducing molten resin in a gap formed between a first mold member and a second mold member, wherein the first mold member comprises a predetermined rough surface with projections and depressions and a shape corresponding to a shape of an inner surface of the hollow portion defining the chamber and the second mold member has a shape corresponding to an outer shape of the hollow portion. The method of forming the groove further comprises separating the first mold member from the resin after the resin is cured, and forming the groove by sliding the predetermined rough surface against the inner surface of the hollow portion during separation of the first mold member from the resin.

According to yet another embodiment of the present invention, an inkjet printer comprises an ink cartridge. The ink cartridge comprises a frame comprising at least a portion of a first chamber formed therein, wherein the first chamber is configured to store ink. The ink cartridge also comprises a hollow portion positioned at a side wall of the frame, wherein the hollow portion comprises a second chamber formed therein, the second chamber is in fluid communication with the first chamber and extends from an inner surface of the side wall of the frame away from the first chamber. The ink cartridge further comprises a movable member positioned in the second chamber and configured to move in response to an amount of ink in the first chamber, wherein an inner surface of the hollow portion defining the second chamber has a groove formed therein and extending toward the first chamber.

Other objects, features, and advantages of embodiments of the present invention will be apparent to persons of ordinary skill in the art from the following description of embodiments with reference to the accompanying drawings.

### BRIEF DESCRIPTION OF DRAWINGS

For a more complete understanding of the present invention, the needs satisfied thereby, and the objects, features, and advantages thereof, reference now is made to the following description taken in connection with the accompanying drawings.

FIG. 1 is a perspective view of an ink cartridge, according to an embodiment of the present invention.

FIG. 2(A) is a front view of the ink cartridge of FIG. 1.

FIG. 2(B) is a cross-sectional view of the ink cartridge of FIG. 1.

FIG. 3 is an enlarged view of a portion III surrounded by a dashed-line circle in

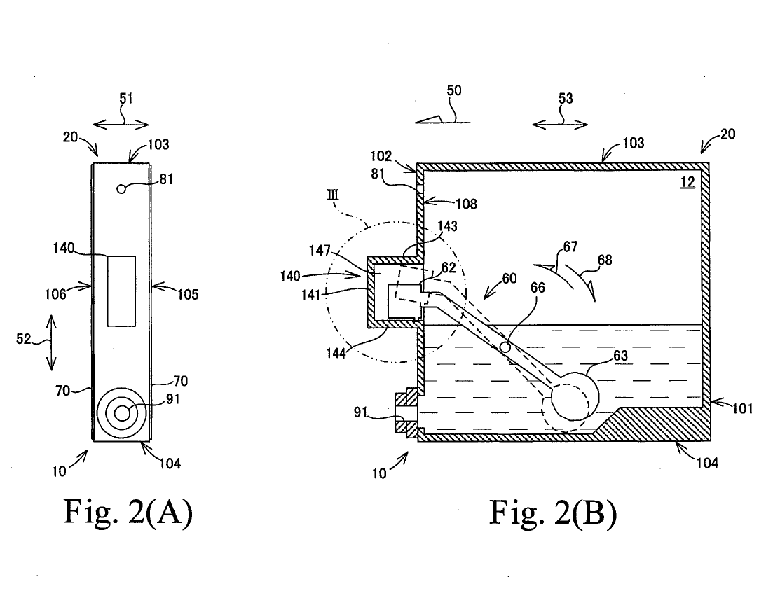

FIG. 2(B), according to an embodiment of the invention.

FIG. 4(A) is a drawing illustrating a method of forming a groove in an inner surface of a hollow portion of the ink cartridge, according to an embodiment of the invention.

FIG. 4(B) is another drawing illustrating a method of forming a groove in an inner surface of a hollow portion of the ink cartridge, according to an embodiment of the invention.

FIG. 5 is an enlarged image of the inner surface of the hollow portion according to a first example of the invention.

FIG. 6 is a cross-sectional view of an ink supply device during the mounting of an ink cartridge to the ink supply device according to an embodiment of the invention.

FIG. 7 is a cross-sectional view of the ink supply device and the ink cartridge when the ink cartridge is mounted to the ink supply device.

FIG. 8 is an enlarged view of the portion III surrounded by a dashed-line circle in FIG. 2(B), according to another embodiment of the invention.

### DETAILED DESCRIPTION OF EMBODIMENTS

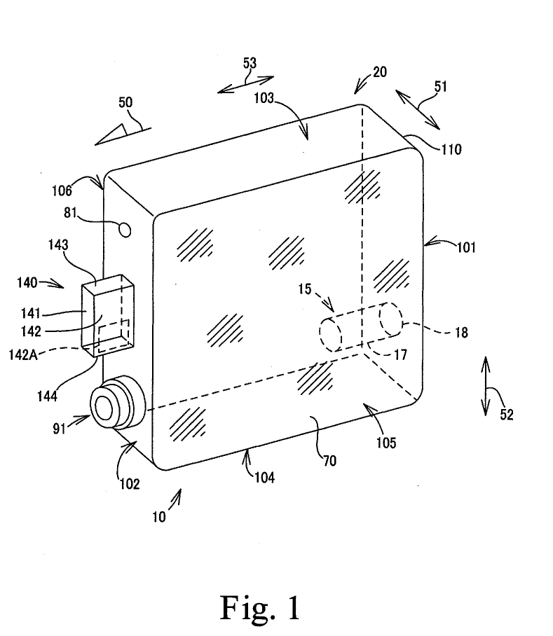

Embodiments of the invention and their features and technical advantages may be understood by referring to FIGS. 1-8, like numerals being used for like corresponding portions in the various drawings. Moreover, references to “left” and “right,” “front” and “rear,” and “upper” and “lower” are with respect to the orientation depicted in the drawings.

Referring to FIGS. 1, 6, and 7, an ink cartridge 10 may be configured to be used with an ink-jet printer. Ink cartridge 10 may be configured to mount to a cartridge accommodating case 121 of an ink supply device 120 disposed in the ink-jet printer.

Ink cartridge 10 may comprise a case 20, an ink introduction portion 15, a hollow portion 140, a pivotable member 60, an air communication opening 81, and an ink supply opening 91.

Ink cartridge 10 may have a substantially flat, hexahedral shape. Case 20 may have a substantially rectangular parallelepiped shape with a width in a width direction 51, a height in a height direction 52, and a depth in a depth direction 53. Each of the height and the depth may be greater than the width.

Case 20 may comprise a front face 102, a rear face 101 opposite front face 102, an upper face 103, a lower face 104 opposite upper face 103, a left side face 105, and a right side face 106 opposite left side face 105. An area of each of left side face 105 and right side face 160 may be greater than an area of each of front face 102, rear face 101, upper face 103, and lower face 104. Ink cartridge 10 may be configured to be inserted into cartridge accommodating case 121 from front face 102 side in an insertion direction 50 while being oriented in an orientation, as shown in FIG. 1. When ink cartridge 10 is mounted to cartridge accommodating case 121, upper face 103 may be positioned at the top of case 20 and lower face 104 may be positioned at the bottom of case 20.

Case 20 may comprise a frame 110 and films 70. Frame 110 may comprise six faces, which may correspond to six faces 101-106 of case 20. Frame 110 may comprises a translucent material, e.g., a transparent or semi-transparent synthetic resin. Frame 110 may be formed by injection-molding of synthetic resins, e.g., polyacetal, nylon, polyethylene, polypropylene, or combinations thereof. Frame 110 may have a substantially rectangular perimeter along front face 102, upper face 103, rear face 101, and lower face 104, and the perimeters may define a space therein. Openings may be formed in left side face 105 and right side face 106 of frame 110.

Films 70 may comprise a thin, transparent resin-film. Films 70 may be attached to edges of frame 110 on both side faces 105 and 106 by a thermal welding method to close openings in each of side faces 105 and 106. Frame 110 and films 70 may form ink chamber 12 which may be configured to store ink. In another embodiment, ink chamber 12 may be formed in a frame having a parallelepiped container shape.

Referring to FIGS. 1 and 2(B), frame 110 may comprise an ink introduction portion 15 at rear face 101. Ink introduction portion 15 may be positioned slightly below a center portion of rear face 101. Ink introduction portion 15 may comprise a cylindrical chamber 17 which extends from an opening 18 formed through rear face 101 into ink chamber 12. When ink is introduced into the interior of cylindrical chamber 17 from opening 18, the ink may flow into ink chamber 12 via the interior of cylindrical chamber 17. The ink may fill up at least a portion of an inner space 147 formed in hollow portion 140.

Referring to FIGS. 1 to 2(B), hollow portion 140 may extend outwardly from a portion adjacent to a center of front face 102. The amount of ink stored in ink chamber 12 may be detected optically, electrically, or visually through hollow portion 140. Hollow portion 140 may have a substantially rectangular parallelepiped shape with a width in width direction 51, a height in height direction 52, and a depth in depth direction 53. The height of hollow portion 140 may be greater than each of the width and the depth of hollow portion 140. Hollow portion 140 may be defined by a rectangular front wall 141 extending in parallel to front face 102 at a predetermined distance away from front face 102; a pair of rectangular side walls 142 connected to left and right sides of front wall 141, respectively; a rectangular upper wall 143; and a rectangular bottom wall 144 connected to upper and lower sides of front wall 141 respectively. Bottom wall 144 may comprise a bottom inner surface of hollow portion 140.

Both of the width of front wall 141 and the width of hollow portion 140 may be less than the width of front face 102 along width direction 51. Referring to FIGS. 6 and 7, the width of hollow portion 140 may be less than a width distance of a gap positioned between a light-emitting element 113 and an light-receiving element 114 of an optical sensor 123 provided in cartridge accommodating case 121. When cartridge 10 is mounted to cartridge accommodating case 121, hollow portion 140 may be positioned in the gap between light-emitting element 113 and light-receiving element 114, such that light-emitting element 113 and light-receiving element 114 may face the pair of side walls 142, respectively.

Hollow portion 140 may define an inner space 147 formed therein. Inner space 147 may be in fluid communication with ink chamber 12. Inner space 147 may extend from an inner surface 108 of a side wall of frame 110 which defines front face 102 in a direction away from ink chamber 12, and inner space 147 may have a substantially rectangular parallelepiped shape defined by the inner surfaces of respective walls 141 to 144. Inner space 147 may have a shape substantially conforming to that of the exterior shape of hollow portion 140. Inner space 147 may comprise a width in width direction 51, a height in height direction 52, and a depth in depth direction 53. The height of inner space 147 may be greater than the width and the depth of inner space 147. An indicator portion 62 of pivotable member 60 may be positioned in inner space 147. In another embodiment, inner space 147 and hollow portion 140 may be manufactured by forming a recess in the side wall of frame 110 from inner surface 108 of the side wall of frame 110.

Hollow portion 140 may be formed from a translucent material, e.g., a transparent or semi-transparent synthetic resin. Hollow portion 140 may allow light, e.g., visible or infrared light, to pass therethrough. Respective walls 141 to 144 and inner space 147 may allow light to pass therethrough when irradiated with light. Each of side walls 142 may have an area 142A which may be irradiated with light emitted from light-emitting element 113 of optical sensor 123 when ink cartridge 10 is mounted to cartridge accommodating case 121. In another embodiment, at least area 142A of each of side walls 142 may be translucent, and portions other than area 142A may be non-translucent, e.g., opaque.

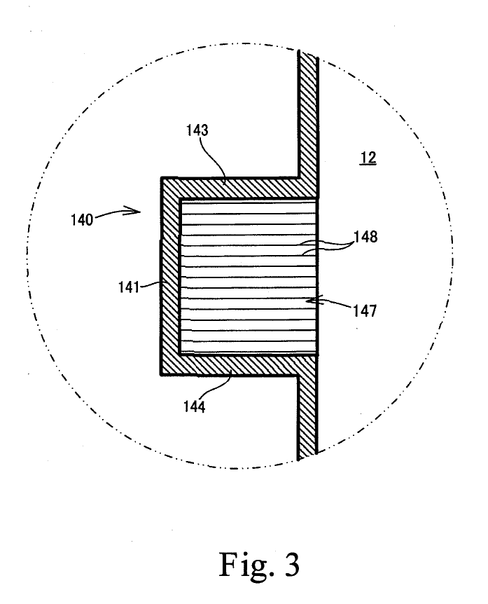

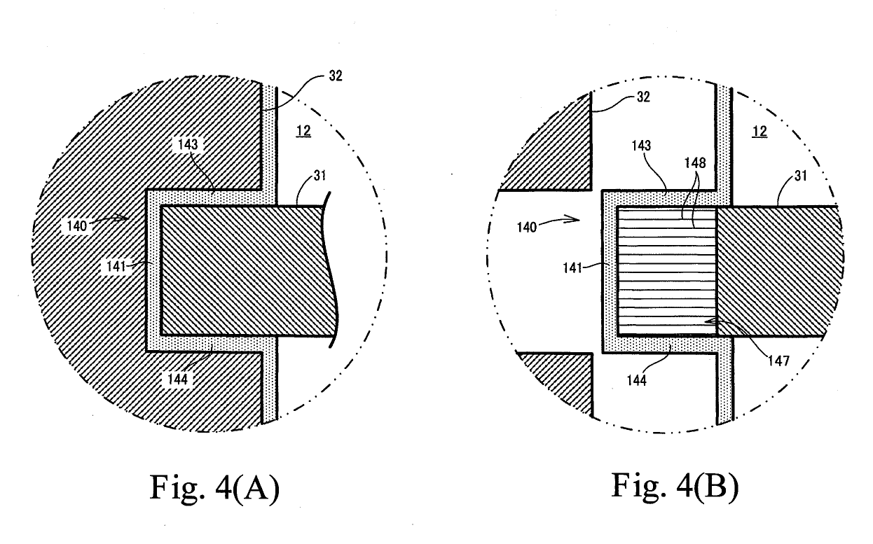

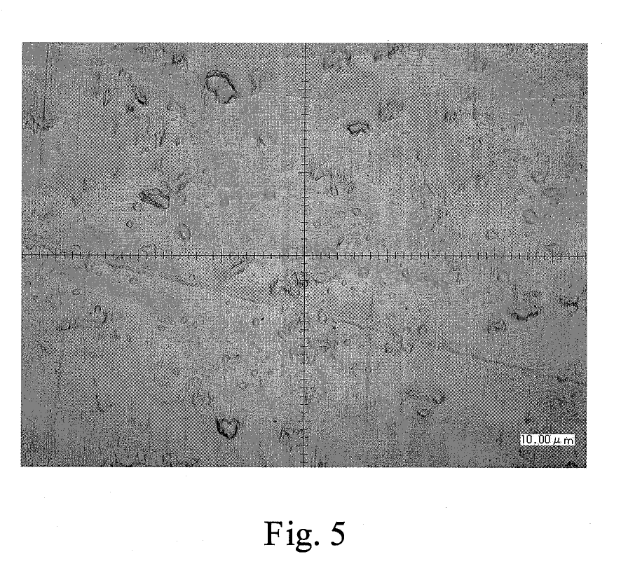

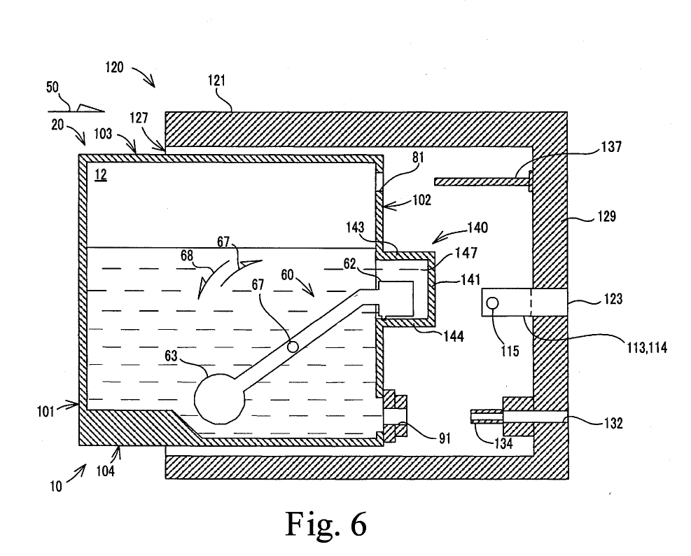

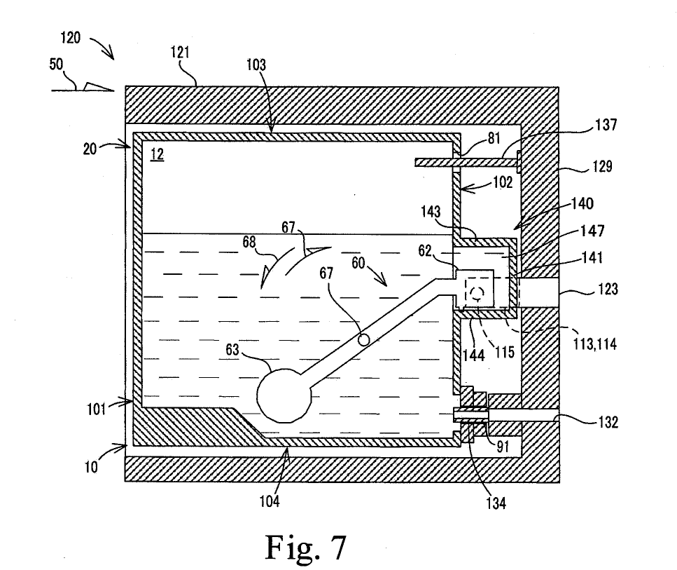

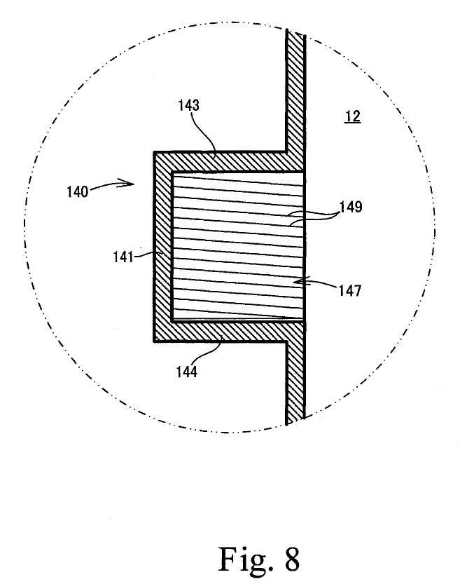

Referring to FIG. 3, the inner surface of hollow portion 140 may comprise a plurality of grooves 148 formed therein. Grooves 148 may extend toward ink chamber 12. Grooves 148 may be formed in the inner surfaces of the pair of side walls 142, the inner surface of upper wall 143, and the inner surface of bottom wall 144, respectively. Thus, grooves 148 may extend in depth direction 53. Grooves 148 may extend substantially horizontally when ink cartridge 10 is mounted to cartridge accommodating case 121. Each of grooves 148 may have a width configured to diffuse ink adhering to the inner surface of hollow portion 140 by capillary action and to move the ink along each of grooves 148.

The width of grooves 148 may be uniform. In another embodiment, grooves 148 may have non-uniform widths within a predetermined width range. The width of groove 148 may be within a range of 0.1 μm<d<100 μm, where d is the width of groove 148. In a preferred embodiment, width d of groove 148 may be within the range of 1 μm≦d≦50 μm.

Hollow portion 140 may be formed integrally with frame 110. When frame 110 is injection-molded, hollow portion 140 may be molded integrally with frame 110. Hollow portion 140 may be molded by using two mold members. Referring to FIGS. 4(A) and 4(B), hollow portion 140 may be formed by injection-molding resin using a first mold member 31 having a shape corresponding to the shape of inner space 147 and a second mold member 32 having a shape corresponding to the shape of the outer surface of hollow portion 140. The surface of first mold member 31 may have fine projections and depressions corresponding to the widths and the depths of grooves 148. The fine projections and depressions may be formed on the surface of first mold member 31 with a predetermined surface roughness. Referring to FIG. 4(A), first mold member 31 and second mold member 32 may be assembled, and melted resin may be poured into a gap formed between the assembled first mold member 31 and second mold member 32. Referring to FIG. 4(B), after the resin is cured, first mold member 31 may be separated from the cured resin to form inner space 147 of hollow portion 140. When first mold member 31 is separated from the cured resin, the fine projections and depressions of first mold member 31 may slide on the resin to form grooves 148 on the contact surface between first mold member 31 and the resin.

The widths and the depths of grooves 148 may vary based on the shapes of the projections and depressions on the surface of first molding member 31. The sizes of the projections and depressions may be determined indirectly by the surface roughness of the surface of first molding member 31. For example, a plurality of inner spaces 147 may be formed using a plurality of first molding members 31 having various surface roughness in conformity with standard prescribed in B0601 of Japan Industrial Standards (JIS). Magnified pictures of the inner surfaces taken with an electron microscope may be analyzed to find the widths of grooves 148 which were formed in the inner surfaces. The surface roughness, which is able to form grooves 148 having desired widths, along with the sizes of the projections and depressions on the surface of first molding member 31 may be determined. Using first molding member 31 having the predetermined surface roughness, grooves 148 having desired widths may be formed on inner surface of hollow portion 140 when first molding member 31 is separated from cured resin.

FIG. 5 is an exemplary enlarged image of grooves 148. The enlarged image shown in FIG. 5 was taken using Super Focal Color 3D Profile Microscope, e.g., type: VK-9500 from KEYENCE CORPORATION. For the measurement of the widths of grooves 148, Shape Analysis Application (VK-H1A9, Ver.:2.2.1.0) was used. Conditions of the measurement were: Magnification: ×20; and Optical Zoom: ×1.

Referring to FIG. 2(B), pivotable member 60 may be positioned in ink chamber 12. Pivotable member 60 may indicate the amount of ink stored in ink chamber 12. Pivotable member 60 may comprise a shaft 66 positioned at substantially the center of pivotable member 60. Shaft 66 may be supported by a shaft supporting portion (not shown) provided on frame 110. Pivotable member 60 may pivot about shaft 66 in ink chamber 12.

Pivotable member 60 may comprise an opaque resin material. Pivotable member 60 may be formed by injection-molding a resin material, and the resin material may comprise one or more of nylon, polyethylene, polypropylene (PP), polycarbonate, polyolefin, and acryl resin, to which black pigment, e.g., carbon black, may be added. Indicator portion 62 may be configured to block light emitted from light-emitting element 113 of optical sensor 123.

Pivotable member 60 may comprise a float portion 63. Float portion 63 may comprise a hollow space formed therein. Float portion 63 may be positioned at an end of pivotable member 60 opposite from indicator portion 62. Float portion 63 may be configured to float on ink and to move up and down according to the ink level in ink chamber 12. When float portion 63 moves, pivotable member 60 may pivot about shaft 66. In another embodiment, float portion 63 may comprise a material which has a specific gravity less than the specific gravity of ink.

Pivotable member 60 may comprise indicator portion 62. Indicator portion 62 may be positioned at an end of pivotable member 63 opposite from float portion 63. Indicator portion 62 may have a thin plate shape extending in height direction 52. When ink cartridge 10 is mounted to cartridge accommodating case 121, indicator portion 62 may extend in the vertical direction. The width of indicator portion 62 in width direction 51 may be less than the height of indicator portion 62. Indicator portion 62 may comprise lightweight material, such that pivotable member 60 may pivot quickly. Portions of pivotable member 60, except for float portion 63, may have a thin plate shape.

Indicator portion 62 may be positioned in inner space 147 of hollow portion 140. Indicator portion 62 may be configured to move in height direction 52 within inner space 147 when pivotable member 60 pivots. When ink cartridge 10 is mounted to cartridge accommodating case 121, indicator portion 62 may be configured to move in the vertical direction within inner space 147 when pivotable member 60 pivots.

Indicator portion 62 may be configured to move between a first position indicated by a solid line in FIG. 2(B), at which the movable member may contact the inner surface of bottom wall 144, and a second position as indicated by a dashed line in FIG. 2(B), at which the movable member may be separated from the inner surface of bottom wall 144 and may contact the inner surface of upper wall 143. When ink cartridge 10 is mounted to cartridge accommodating case 121, the second position may be positioned above the first position.

Referring to FIG. 2(B), when float portion 63 moves up and down according to the position of the ink level in ink chamber 12, pivotable member 60 may pivot, and indicator portion 62 may move up and down in inner space 147 according to the pivotal movement of pivotable member 60. When float portion 63 moves up, pivotable member 60 may pivot in the direction indicated by an arrow 67 in FIG. 2(B), and indicator portion 62 may move down in inner space 147. When indicator portion 62 contacts the inner surface of bottom wall 144 of hollow portion 140, indicator portion 62 may remain at the first position. When indicator portion 62 is positioned at the first position, indicator portion 62 may be positioned between areas 142A of side walls 142, which may be positioned at lower portions of side walls 142, as indicated by a dashed line in FIG. 1. When indicator portion 62 is positioned at the first position, and one of areas 142A is irradiated with light traveling perpendicular to side wall 142, the light passing through area 142A may be blocked by indicator portion 62.

When the amount of ink decreases, float portion 63 may move down corresponding to the decrease of the ink level, pivotable member 60 may pivot accordingly in the direction indicated by an arrow 68 in FIG. 2(B), and indicator portion 62 may move up in inner space 147. When indicator portion 62 contacts the inner surface of upper wall 143 of hollow portion 140, indicator portion 62 may remain at the second position. When indicator portion 62 is positioned at the second position, indicator portion 62 may move away from areas 142A. When indicator portion 62 is positioned at the second position and area 142A is irradiated with light traveling perpendicular to side wall 142, the light may pass through hollow portion 140 without being blocked by indicator portion 62.

Referring to FIG. 7, when ink cartridge 10 is mounted to cartridge accommodating case 121, light may be emitted from light-emitting element 113 of optical sensor 123 to area 142A of one of side walls 142. When indicator portion 62 is positioned at the first position, the light may be blocked by indicator portion 62. When indicator portion 62 is positioned at the second position, the light may reach light-receiving element 114 without being blocked by indicator portion 62. Therefore, the amount of ink in ink chamber 12 may be determined based on the intensity of light received by light-receiving element 114.

Referring to FIGS. 1 to 2(B), air communication opening 81 and ink supply opening 91 may be formed on front face 102 of frame 110. Air communication opening 81 may be formed through front face 102 between hollow portion 140 and an end of front face 102 adjacent to upper face 103. Air communication opening 81 may be configured to place ink chamber 12 in communication with the exterior of ink cartridge 10. When ink cartridge 10 is not used, e.g., when ink cartridge 10 is not mounted to cartridge accommodating case 121, air communication opening 81 may be closed by a sealing member (not shown). Referring to FIGS. 6 and 7, when ink cartridge 10 is mounted to cartridge accommodating case 121, a rod 137 may be inserted into air communication opening 81, such that air communication opening 81 may be opened, and the pressure in ink chamber 12 may become equal to the atmospheric pressure.

Referring to FIGS. 1 to 2(B), ink supply opening 91 may be formed through front face 102 between hollow portion 140 and an end of front face 102 adjacent to lower face 104. Ink supply opening 91 may be configured to supply ink from ink chamber 12 to the exterior of ink cartridge 10. When ink cartridge 10 is not used, e.g., when ink cartridge 10 is not mounted to cartridge accommodating case 121, ink supply opening 91 may be closed by a sealing member (not shown). Referring to FIGS. 6 and 7, when ink cartridge 10 is mounted to cartridge accommodating case 121, an ink tube 134 may be inserted into ink supply opening 91, such that ink may be supplied from ink cartridge 10 to a print head of the inkjet printer via ink tube 134.

The sealing members may comprise adhesive films which cover air communication opening 81 and ink supply opening 91, respectively, or valves which respectively close air communication opening 81 and ink supply opening 91 from ink chamber 12 side by urging devices, e.g., springs.

Referring to FIGS. 6 and 7, ink supply device 120 may be provided in the ink-jet printer. Ink supply device 120 may be configured to supply ink to the print head of the ink-jet printer. Ink supply device 120 may comprise cartridge accommodating case 121, to which ink cartridge 10 may be mounted.

Cartridge accommodating case 121 may be configured to mount and accommodate ink cartridge 10 therein. Cartridge accommodating case 121 may comprise an opening 127 formed therein. Ink cartridge 10 may be inserted into cartridge accommodating case 121 via opening 127.

Optical sensor 123 may be disposed at a wall 129 which is positioned opposite from opening 127 of cartridge accommodating case 121. Optical sensor 123 may be electrically connected to a controller (not shown) of the ink-jet printer. Optical sensor 123 may be configured to detect indicator portion 62 in hollow portion 140. Optical sensor 123, e.g., a transmissive photo interrupter, may comprise light-emitting element 113 and light-receiving element 114. When ink cartridge 10 is mounted to cartridge accommodating case 121, hollow portion 140 may be inserted in between light-emitting element 113 and light-receiving element 114 of optical sensor 123, and hollow portion 140 may intersect an optical path 115 formed between light-emitting element 113 and light-receiving element 114. Area 142A of each of side walls 142 of hollow portion 140 may intersect optical path 115.

Wall 129 may comprise an opening 132 formed therethrough. Opening 132 may extend from the inner surface of wall 129 to the outer surface of wall 129. Ink tube 134 may extend from the inner surface of wall 129 toward opening 127, and the interior of ink tube 134 may be continuous with opening 132. A flexible tube (not shown) may be connected to the outer surface of wall 129, such that the interior of the flexible tube may be continuous with opening 132. The flexible tube may be connected to the print head. When ink cartridge 10 is mounted to cartridge accommodating case 121, ink tube 134 may be inserted into ink supply opening 91, and an ink path extending from ink supply opening 91 to the flexible tube may be formed.

Rod 137 may extend from the inner surface wall 129 toward opening 127. When ink cartridge 10 is mounted to cartridge accommodating case 121, rod 137 may be inserted into air communication opening 81. Ink chamber 12 and the exterior of ink cartridge 10 may be brought into fluid communication via air communication opening 81.

A plurality of grooves 148 may be formed in the inner surface of hollow portion 140, e.g., the inner surfaces of side walls 142, the inner surface of upper wall 143, and the inner surface of bottom wall 144. When ink stored in ink chamber 12 of ink cartridge 10 is consumed and the ink liquid level in ink chamber 12 gradually lowers, ink stored in inner space 147 may be drawn by ink stored in ink chamber 12 and may be guided to ink chamber 12 along grooves 148. Because ink stored in inner space 147 is guided to ink chamber 12, ink may not accumulate at the inner surface of bottom wall 144 of hollow portion 140. Therefore, contact between indicator portion 62 and the accumulated ink may be prevented, and indicator portion 62 may move smoothly in inner space 147. Because adhesion of ink droplets to the inner surface of side walls 142 is avoided by grooves 148, diffusion of light from light-emitting element 113 by the lens effect of the ink droplets may be prevented, and, therefore, detection accuracy of optical sensor 123 may be improved.

Grooves 148 may be configured to draw ink adhering to the inner surface of hollow portion 140 from hollow portion 140 by capillary action. Therefore, even though the ink droplets may adhere to the inner surface of hollow portion 140, the ink droplets may not fall on the inner surface of bottom wall 144 of hollow portion 140. The ink droplets may be guided toward ink chamber 12 while being diffused toward ink chamber 12 by the capillary action of grooves 148. Therefore, ink may be prevented from accumulating at the inner surface of bottom wall 144 of hollow portion 140.

The width of groove 148 may be greater than 0.1 μm and less than 100 μm. Ink stored in ink cartridge 10 may comprise pigment ink or dye ink. The average diameter of particles of the pigment may be about 0.1 μm. Therefore, even when the pigment ink is used, because grooves 148 have widths greater than the diameter of the particles of the pigment, ink may be guided to ink chamber 12 along grooves 148. Because the width of groove 148 is less than 100 μm, ink may not retained in grooves 148, and the movement of indicator portion 62 may not be hindered by ink held in grooves 148.

Preferably, the width of groove 148 may be greater than or equal to 1 μm and less than or equal to 50 μm. The diameter of the particles of the pigment may not be uniform and may vary. Therefore, in order to account for the variations in the diameter of the particles of ink, the lower limit value of the width of groove 148 may be set to 1 μm, which is greater than 0.1 μm. The surface tension of ink may not be uniform and may vary according to the type of ink or other factors. Therefore, the upper limit value of the width of groove 148 may be set to 50 μm which is less than 100 μm. Therefore, ink may be drawn efficiently toward ink chamber 12 irrespective of the variations in diameter of the particles of the pigment or the variations in the ink's surface tension.

Inner space 147 and grooves 48 with the desired widths may be formed simultaneously using first mold member 31 having a predetermined surface roughness.

Grooves 148 may extend in depth direction 53, and may extend horizontally when ink cartridge 10 is mounted to cartridge accommodating case 121. In another embodiment, grooves 149 may extend toward ink chamber 12 and gradually may incline toward ink supply opening 91, i.e., may extend toward ink chamber 12 and downward when ink cartridge 10 is mounted to cartridge accommodating case 121, as shown in FIG. 8. Grooves 149 may prevent accumulation of ink at the ends of grooves 149 adjacent to front wall 141 of hollow portion 140. Ink droplets adhering to the inner surface of hollow portion 140 may be guided toward ink chamber 12 by the weight of the ink droplets and by the capillary force of grooves 149. Grooves 149 are configured in the same manner as described above for grooves 148, except for the inclination.

Examples of embodiments of the present invention are described below. Nevertheless, the present invention is not limited in scope to the examples described below.

Ink cartridges of Examples 1-3 were manufactured in accordance with ink cartridge 10 described in the embodiments above, and were tested in comparison with ink cartridges of Comparative Examples 1-3 which also were manufactured in accordance with the ink cartridge 10 described in the embodiments above. Frames 110 and films 70 of these cartridges were made of polypropylene. Ink was poured into ink chamber 12 in amount which does not reach inner space 147 when the ink cartridge was orientated in a mounted orientation, e.g., the orientation shown in FIG. 1, which is the orientation in which the ink cartridge is mounted to cartridge accommodating case 121. Pigment ink having a surface tension of 36.0 mN/m (Type LC10Bk of Brother Industries, Ltd.) was used. The measurement of the surface tension of the pigment ink was performed on the basis of the known Wilhelmy method using a fully automatic surface tension meter (e.g., Kyowa Interface Science Co., Ltd.; type CBVP-Z).

### Example 1

In the ink cartridge of Example 1, hollow portion 140 and inner space 147 were formed using a metal mold having a surface roughness of 0.8 μm in conformity with standard prescribed in B0601 of Japan Industrial Standards (JIS). Grooves having an average width of 5 μm were found formed in the inner surface of hollow portion 140. The widths of the grooves were measured by taking the image of the inner surface of hollow portion 140 under the following measurement conditions using Super Focal Color 3D Profile Microscope (type: VK-9500 from KEYENCE CORPORATION, Magnification: ×20, Optical Zoom: ×1), and by analyzing the image data with Shape Analysis Application (VK-H1A9, Ver.:2.2.1.0). More specifically, ten grooves were chosen at random by Shape Analysis Application, the widths of the respective chosen grooves were measured by this analysis application, and the average value of the widths was calculated. The calculated average value was defined as the groove width in Example 1.

### Example 2

In the ink cartridge of Example 2, hollow portion 140 and inner space 147 were formed using a metal mold having a surface roughness of 0.4 μm in conformity with standard prescribed in B0601 of Japan Industrial Standards (JIS). Grooves having an average width of 1 μm were found formed in the inner surface of hollow portion 140. The widths of the grooves were measured by the same measuring method as in Example 1.

### Example 3

In the ink cartridge of Example 3, hollow portion 140 and inner space 147 were formed using a metal mold having a surface roughness of 5.0 μm in conformity with standard prescribed in B0601 of Japan Industrial Standards (JIS). Grooves having an average width of 50 μm were found to be formed in the inner surface of hollow portion 140. The widths of the grooves were measured by the same measuring method as in Example 1.

### Comparative Example 1

In the ink cartridge of Comparative Example 1, hollow portion 140 and inner space 147 were formed using a metal mold having a surface roughness of 10.0 μm in conformity with standard prescribed in B0601 of Japan Industrial Standards (JIS). Grooves having an average width of 100 μm were found to be formed in the inner surface of hollow portion 140. The widths of the grooves were measured by the same measuring method as in Example 1.

### Comparative Example 2

In the ink cartridge of Comparative Example 2, hollow portion 140 and inner space 147 were formed using a metal mold having a surface roughness of 0.1 μm in conformity with standard prescribed in B0601 of Japan Industrial Standards (JIS). Grooves having an average width of 0.1 μm were found to be formed in the inner surface of hollow portion 140. The widths of the grooves were measured by the same measuring method as in Example 1.

### Comparative Example 3

In the ink cartridge of Comparative Example 3, hollow portion 140 and inner space 147 were formed using a metal mold having a surface roughness of 0.05 μm in conformity with standard prescribed in B0601 of Japan Industrial Standards (JIS). Existence of things which could be evaluated as grooves was not found to be formed in the inner surface of the hollow portion 140. In other words, no groove was formed in the inner surface of hollow portion 140.

### [Evaluation Test 1]

A test was conducted in the following manner using the respective ink cartridges of Examples 1-3, and of Comparative Examples 1-3. Each ink cartridge was inclined, such that each of its inner space 147 was filled with ink, and then the ink cartridge was returned to the mounted orientation, such that ink started to move from inner space 147 to ink chamber 12. Then, the presence or absence of ink in the inner space 147 immediately after the ink cartridge was returned to the mounted orientation was visually observed. A detecting test using infrared light having 940 nm wavelength also was conducted. In the detecting test, areas 142A of side walls 142 were irradiated with the infrared light, and whether or not the intensity of the infrared light which passed through areas 142A of side walls 142 is greater than or equal to a predetermined value was determined. The above-described tests were performed three times for each of Examples 1-3 and Comparative Examples 1-3.

### [Method of Evaluation 1]

When no ink droplet was visually found on the inner surface of hollow portion 140 at any time of the test, the test result was evaluated as “absent.” Otherwise, the test result was evaluated as “present.” When the average value of the transmittance of the infrared light which passed through hollow portion 140 was greater than or equal to 50%, the test result was evaluated as “possible.” Otherwise, the test result was evaluated as “impossible.” If the test result of the detection test is “possible,” the determination of the amount of ink in ink chamber 12 using optical sensor 123 may be made accurately.

### [Result of Evaluation 1]

The result of the evaluation tests is depicted in Table 1.

TABLE 1
Result of Evaluation Test 1

| | Example | | | Comparative Example | | |
|---|---|---|---|---|---|---|
| | 1 | 2 | 3 | 1 | 2 | 3 |
| Groove | 5 | 1 | 50 | 100 | 0.1 | No |
| Width | | | | | | Groove |
| (μm) | | | | | | |
| Presence | Absent | Absent | Absent | Present | Present | Present |
| or | | | | | | |
| Absence | | | | | | |
| of Ink | | | | | | |
| Detecting | Possible | Possible | Possible | Impossible | Impossible | Impos- |
| Test | | | | | | sible |

As shown in Table 1, adhesion of ink in inner space 147 was not found visually in Examples 1-3. In the detecting test, transmittance greater than or equal to the predetermined value was obtained in Example 1 to Example 3. In contrast, adhesion of ink in inner space 147 was found visually in Comparative Examples 1-3. In the detecting test, transmittance greater or equal to the predetermined value was not obtained in Comparative Examples 1-3. Therefore, it was confirmed that when at least the grooves having the width d in the range of 1 μm≦d≦50 μm were formed in the inner surface of hollow portion 140, ink moved quickly from inner space 147 to ink chamber 12, without remaining ink droplets or accumulated ink in inner space 147.

### Example 4

In Example 4, pigment ink (Brother Industries Co., Ltd., type: LC10Bk) was used. The surface tension of the ink was 35.7 mN/m. The measurement of the surface tension was performed on the basis of known Wilhelmy method using a full automatic, surface tension meter (Kyowa Interface Science Co., Ltd.; type CBVP-Z). More specifically, the surface tension was measured three times, and the average value was calculated. The calculated value was defined as the surface tension of the ink of Example 4. The measurement of the surface tension was carried out in the same manner in Example 5 and Comparative Example 4 to Comparative Example 8.

### Example 5

In Example 5, pigment ink (Brother Industries Co., Ltd., type: BK1), to which acetylene diol type surface-active agent was added in an amount of 0.05%, was used. The surface tension of the ink was 32.9 mN/m.

### Comparative Example 4

In Comparative Example 4, pigment ink (Brother Industries Co., Ltd., type: LC09Bk) used in the ink-jet printer (Brother Industries Co., Ltd., type: DCP-110C) was prepared. The surface tension of the ink was 38.9 mN/m.

### Comparative Example 5

In Comparative Example 5, pigment ink (Brother Industries Co., Ltd., type: BK2), to which acetylene diol-type, surface-active agent was added in an amount of 0.1%, was prepared. The surface tension of the ink was 29.7 mN/m.

### Comparative Example 6

As Comparative Example 6, pigment ink (Brother Industries Co., Ltd., type: BK3), to which acetylene diol-type, surface-active agent was added in an amount of 0.1%, was prepared. The surface tension of the ink was 30.0 mN/m.

### Comparative Example 7

In Comparative Example 7, pigment ink (Brother Industries Co., Ltd., type: BK4), to which alkanol amide-type, surface-active agent was added in an amount of 0.27%, was prepared. The surface tension of the ink was 29.7 mN/m.

### Comparative Example 8

In Comparative Example 8, pigment ink (Brother Industries Co., Ltd., type: BK5), to which alcohol-type, surface-active agent was added in an amount of 0.3%, was prepared. The surface tension of the ink was 31.4 mN/m.

### [Evaluation Test 2]

Tests for observing diffusion and dropping of ink in a test piece were conducted using inks of Examples 4 and 5, and Comparative Examples 4-8 and the test piece having a plurality of grooves extending in a width direction (horizontal direction) and having the width d in the range of 5 μm≦d≦50 μm. Resin piece having a plate-rod shape was used as the test piece. The test piece had a thickness of 3 mm, a width of 10 mm, and a length of 70 mm. A method of forming the plurality of grooves in the test pieces was substantially the same as the method of forming grooves 148 in the inner surface of the hollow portion 140 in the above-described embodiment. More specifically, melted resin was molded into the test piece using a mold member having a predetermined surface roughness. The plurality of grooves were formed in the surface of the test piece by separating the mold member from the cured resin while the surface of the mold member slides on the cured resin. The test pieces used in the test were made of polypropylene. This evaluation test was conducted by positioning the test pieces in the respective tanks in which the respective ink were stored to a depth of 50 mm, soaking the test pieces for 30 seconds, pulling out the test pieces to the atmospheric, and then measuring the time it takes for the ink adhering on the surfaces of the test pieces to fall off. The above-described test was performed three times for each of Examples 4 and 5 and Comparative Examples 4-8.

### [Method of Evaluation 2]

Evaluation Test 2 was intended to determine whether various types of ink are applicable to ink cartridge 10 having plurality of grooves 148 with the width d in the range of 5 μm≦d≦50 μm formed in the inner surface of hollow portion 140. If ink moved along the grooves in the width direction and fell from the test piece without any remaining ink droplets adhering to the test piece within a limited time, e.g., three minutes, after the test piece was pulled out from the ink tank, it was determined that the ink is preferably used in ink cartridge 10. If the ink droplets did not fall within the limited time, it was determined that the ink is not preferable.

### [Result of Evaluation 2]

The result of the evaluation tests was as shown in Table 2.

TABLE 2
Result of Evaluation Test 2

| | | Time |
|---|---|---|
| | Surface Tension/mN/m | required for ink to fall |
| Example 4 | 35.7 | 12 seconds |
| Example 5 | 32.9 | 24 seconds |
| Comparative Example 4 | 38.9 | Greater than 3 minutes |
| Comparative Example 5 | 29.7 | Greater than 3 minutes |
| Comparative Example 6 | 30.0 | Greater than 3 minutes |
| Comparative Example 7 | 29.7 | Greater than 3 minutes |
| Comparative Example 8 | 31.4 | Greater than 3 minutes |

As shown in Table 2, in Examples 4 and 5, ink droplets fell from the test pieces within the limited time, i.e., greater than three minutes. In Examples 4 and 5, ink was diffused along the grooves formed in the test pieces in the width direction, and then the ink fell vertically along the side surfaces of both width ends of the test pieces. In Comparative Examples 4-8, ink did not diffuse along the grooves in the width direction within the limited time of three minutes, and the ink did not fall from the test pieces. Therefore, ink having the surface tension of 32.0 to 36.0 mN/m was easily diffused along the grooves having the width d of at least 5 μm≦d≦50 μm. Therefore, ink having the surface tension of 32.0 to 36.0 mN/m moves quickly from inner space 147 to ink chamber 12 along the grooves when at least the grooves having the width d in the range of 5 μm≦d≦50 μm are formed in the inner surface of hollow portion 140.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. An ink cartridge comprising:
a frame comprising at least a portion of a first chamber formed therein, wherein the first chamber is configured to store ink;
a hollow portion positioned at a side wall of the frame, wherein the hollow portion comprises a second chamber formed therein, the second chamber is in fluid communication with the first chamber and extends from an inner surface of the side wall of the frame away from the first chamber; and
a movable member positioned in the second chamber and configured to move in response to an amount of ink in the first chamber, wherein an inner surface of the hollow portion defining the second chamber has a groove formed therein and extending toward the first chamber.

2. The ink cartridge of claim 1, wherein the movable member is configured to move between a first position at which the movable member contacts a portion of the inner surface of the hollow portion and a second position at which the movable member is separated from the portion of the inner surface of the hollow portion.

3. The ink cartridge of claim 2, wherein the movable member is positioned at the second position when an amount of ink in the first chamber is less than a predetermined amount, and is positioned at the first position when the amount of ink in the first chamber is greater than or equal to the predetermined amount.

4. The ink cartridge of claim 1, wherein the groove is configured to draw ink adhering to the inner surface of the hollow portion toward the first chamber by a capillary action.

5. The ink cartridge of claim 1, wherein the frame has a height in a height direction, a width in a width direction, and a depth in a depth direction, wherein the second chamber extends from the inner surface of the side wall of the frame in the depth direction, the movable member has a plate shape extending in the height direction, and a width of the second chamber is less than a width of the first chamber in the width direction.

6. The ink cartridge of claim 1, further comprising a pivotable member positioned in the first chamber, wherein the pivotable member comprises the movable member at a first end of the pivotable member and a float portion at a second end of the pivotable member, and the movable member is configured to move corresponding to a movement of the float portion in the first chamber.

7. The ink cartridge of claim 1, wherein the frame has a height in a height direction, a width in a width direction, and a depth in a depth direction, wherein the second chamber extends from the inner surface of the side wall of the frame in the depth direction, and the groove extends in the depth direction.

8. The ink cartridge of claim 1, further comprising an ink supply opening configured to supply ink from the first chamber to an exterior of the frame, wherein the groove extends toward the first chamber and inclines toward the ink supply opening.

9. The ink cartridge of claim 1, wherein a width of the groove is greater than 0.1 μm and less than 100 μm.

10. The ink cartridge of claim 9, wherein the width of the groove is greater than or equal to 1 μm and less than or equal to 50 μm.

11. The ink cartridge of claim 1, wherein the hollow portion comprises a translucent portion, and the movable member is configured to move in the translucent portion.

12. The ink cartridge of claim 1, wherein the hollow portion is disposed within the side wall of the frame.

13. A method of forming a groove in an ink cartridge, the ink cartridge comprises a frame comprising a hollow portion positioned at a side wall of the frame, wherein the hollow portion comprises a chamber formed therein, the chamber extends from an inner surface of the side wall of the frame, the method of forming the groove comprises the steps of:
introducing molten resin in a gap formed between a first mold member and a second mold member, wherein the first mold member comprises a predetermined rough surface with projections and depressions and a shape corresponding to a shape of an inner surface of the hollow portion defining the chamber and the second mold member has a shape corresponding to an outer shape of the hollow portion;
separating the first mold member from the resin after the resin is cured; and
forming the groove by sliding the predetermined rough surface against the inner surface of the hollow portion during separation of the first mold member from the resin.

14. An inkjet printer, comprising
an ink cartridge, the ink cartridge comprising:
a frame comprising at least a portion of a first chamber formed therein, wherein the first chamber is configured to store ink;
a hollow portion positioned at a side wall of the frame, wherein the hollow portion comprises a second chamber formed therein, and the second chamber is in fluid communication with the first chamber and extends from an inner surface of the side wall of the frame away from the first chamber in a horizontal direction when the ink cartridge is mounted to the inkjet printer; and
a movable member positioned in the second chamber and configured to move in response to an amount of ink in the first chamber, wherein an inner surface of the hollow portion defining the second chamber has a groove formed therein and extending toward the first chamber.

15. The inkjet printer of claim 14, wherein the movable member is configured to move between a first position at which the movable member contacts a portion of the inner surface of the hollow portion and a second position at which the movable member is separated from the portion of the inner surface of the hollow portion, and when the ink cartridge is mounted to the inkjet printer the second position is above the first position.

16. The inkjet printer of claim 14, wherein the movable member has a plate shape extending in a vertical direction when the ink cartridge is mounted to the inkjet printer, and a width of the second chamber is less than a width of the first chamber in a horizontal direction when the ink cartridge is mounted to the inkjet printer.

17. The inkjet printer of claim 14, wherein the groove extends downward and toward the first chamber when the ink cartridge is mounted to the inkjet printer.
